(19) United States
(12) Patent Application Publication
(10) Pub. No.: US 2017/0018029 A1
(43) Pub. Date: Jan. 19, 2017

(54) SYSTEMS AND METHODS FOR UTILIZING A MONEY TRANSFER NETWORK TO FACILITATE LENDING

(71) Applicant: Moneygram International, Inc., Minneapolis, MN (US)

(72) Inventors: Adriana Beatriz Eiriz, Manhattan Beach, CA (US); David Allan Motley, St. Paul, MN (US)

(21) Appl. No.: 14/801,504

(22) Filed: Jul. 16, 2015

(51) Int. Cl. G06Q 40/02

(52) U.S. Cl. CPC G06Q 40/025

(57) ABSTRACT

Embodiments of systems, methods, and computer-readable storage media for processing loans using resources of a money transfer network are provided. The disclosed embodiment provide techniques for utilizing non-credit transactions executed via a money transfer network to establish credit worthiness and risk assessment for loans requested by borrowers, and may enable borrowers with little or no credit history to obtain loans that they may otherwise be unable to obtain. Further, the disclosed embodiments may utilize the money transfer service provider's expertise in anti-money laundering and other illicit financial behaviors to prevent the loans from being obtained for illicit purposes. Embodiments may also use information that may otherwise be unknown to the lender to generate a recommendation to the lender regarding whether the loan should be approved or denied.

### TECHNICAL FIELD

The present disclosure relates to processing lending transactions, and more particularly to utilizing a money transfer network to process and authorize lending transactions.

### BACKGROUND

People use loans for a variety of purposes, such as to obtain working capital for a business, pay unexpected expenses, purchase homes or automobiles, or other purposes. The amount of a loan is often dependent upon the intended purpose of funds provided in connection with the loan (e.g., loans for the purchase of a home are often associated with a higher loan amount than loans for the purchase of an automobile). The amount of the loan may further dictate the level of due diligence that must be performed prior to a lender authorizing the loan. For example, lenders may require that a borrower seeking a loan for a large amount of money provide more information (e.g., income information, employment history information, asset information, credit information, etc.) to the lender than a borrower seeking a loan for a small amount of money. Collecting and processing this information often takes a significant amount of time, which delays the provisioning of funds in connection with the loan.

Additionally, although the information required for different loans and/or different lenders may vary, lenders almost universally require that the borrower have an established credit history, and associated credit score, before approving the borrower's loan. Thus, individuals having no credit history are often unable to obtain loans without first obtaining some alternative form of credit, such as a credit card. For many individuals obtaining a credit card is not sound option, as the individual may not be able to use the credit card for the same purposes as they otherwise intend to use the funds of the loan. For example, an individual with no credit history who is trying to obtain working capital for a small business may need to obtain a loan to pay all or a portion of the businesses lease, and the landlord may not accept payments via credit cards. Thus, the individual may be precluded from obtaining the working capital needed for his or her business, or may be delayed a significant period of time (e.g., until the individual can establish sufficient credit to obtain a loan), allowing competitors to enter the market or increase market share within the market.

Microlending is a special type of loan transaction (e.g., a microloan) that is typically associated with a small loan amount (e.g., less than $1,000), and designed to promote entrepreneurship, alleviate poverty, empower women, and/or fulfill another beneficial need to members of society. Microlending may help improve the quality of life for individuals living in many parts of the world, such as sub-saharan Africa. However, it is often the case that lenders willing to fund/provide microloans are not locally available in such places. Further, borrowers that would like to obtain microloans often do not possess or have access to technology (e.g., computers, internet access, etc.) that may be utilized to connect the borrowers with remotely located microloan lenders. Thus, although microloans and microlending are designed to promote entrepreneurship, alleviate poverty, empower women, and/or fulfill another beneficial need to members of society, for many such persons the ability to achieve such benefits remains elusive.

### BRIEF SUMMARY

The present disclosure is directed to embodiments of systems, methods, and computer-readable storage media for processing loans using resources of a money transfer network are provided. The disclosed embodiments provide techniques for utilizing non-credit transactions executed via a money transfer network to establish credit worthiness and/or risk assessment for loans requested by borrowers, and may enable borrowers with little or no credit history to obtain loans that they may otherwise be unable to obtain. Further, the disclosed embodiments may utilize the money transfer service provider's expertise in anti-money laundering and other illicit financial behaviors to prevent the loans from being obtained for illicit purposes. Embodiments may also use information that may otherwise be unknown to the lender to generate a recommendation to the lender regarding whether the loan should be approved or denied.

Using resource of the money transfer network in connection with loan transactions according to embodiments of the present disclosure may also facilitate a simple and efficient repayment of the loans. For example, the money transfer network may include or connect money transfer agent locations across cities and states, or even across different countries, and may also connect borrowers and lenders in geographically remote places. Once a loan has been executed between a lender and a borrower, the borrower may receive funds in connection with the loan from a local money transfer agent location, and may provide one or more loan payments to the local money transfer agent location that in turn provides funds for repayment of the loan to the geographically remote lender.

The systems, methods, and computer-readable storage media of embodiments may enable borrowers to engage in loan transactions with lenders that are geographically remote (e.g., in a different city, state, or country) to the borrower, and may also provide techniques for obtaining loans by persons in areas where loans would otherwise be unobtainable (e.g., due to lack of credit, lack of a local or regional lending institution, etc.). As an example, in some regions of Sub Saharan Africa lenders may not have physical presence, which limits the ability to obtain loans by persons residing within those regions. Processing and providing loan transactions using the resources of the money transfer network, as in one or more of the disclosed embodiments, may allow borrowers in such regions to be connected to remote lenders who may provide the borrowers with a loan, as described in more detail below. As another example, in other regions of Sub Saharan Africa lenders may have a presence, but may be unwilling to provide loans below a threshold amount, which may be significantly more than a loan amount many potential borrowers would need and/or qualify for. Processing and providing loan transactions using the resources of the money transfer network, as in one or more of the disclosed embodiments, may allow borrowers in such regions to be connected to remote lenders who may provide the borrowers with loans for amounts more appropriate to the borrower's needs and/or abilities, as described in more detail below.

The foregoing has outlined rather broadly the features and technical advantages of the present disclosure in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the scope of the present disclosure as set forth in the appended claims. The novel features which are believed to be characteristic of embodiments described herein, both as to its organization and method of operation, together with further objects and advantages will be better understood from the following written description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference should be made to the embodiments illustrated in greater detail in the accompanying drawings, wherein:

FIG. 1 is a block diagram of a system for processing loans via a money transfer network;

FIG. 2 is a flow diagram illustrating an exemplary embodiment of a method for processing loans via a money transfer network; and

FIG. 3 is a diagram illustrating exemplary aspects of a loan transaction according to embodiments.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

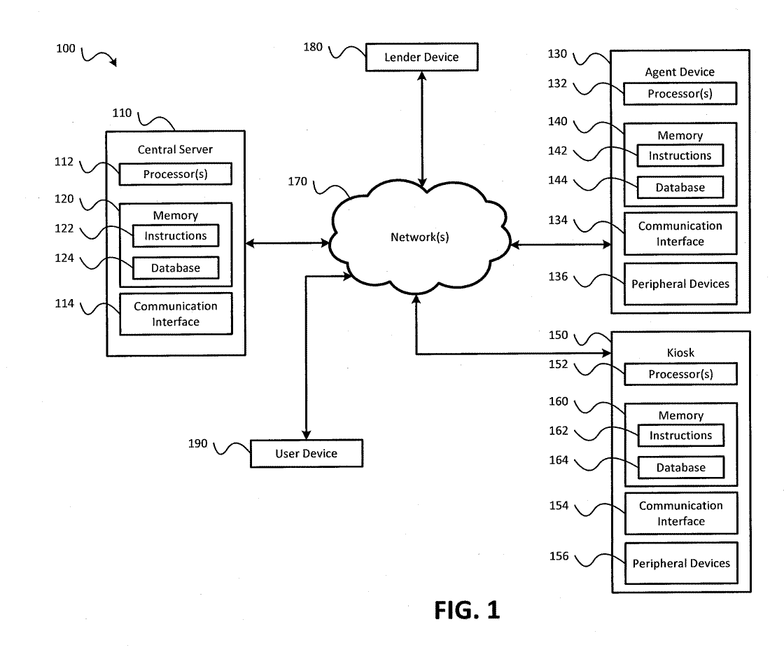

Referring to FIG. 1, FIG. 1 is a block diagram of a system for processing loans via a money transfer network is shown as a system 100. As shown in FIG. 1, the system 100 includes a central server 110, an agent device 130, and a kiosk 150, a lender device 180, and a user device 190, each of which is communicatively coupled via network 170. The central server 110, the agent device 130, and the kiosk 150 may be operated by a money transfer service provider, and may be part of a money transfer network that includes other agent devices, kiosks, and servers that are geographically distributed (e.g., located in different parts of a city, located in different cities, located in different states, located in different countries, etc.).

As shown in FIG. 1, the central server 110 includes a processor 112, a communication interface 114, and a memory 120. It is noted that the processor 112 may include more than one processor, and each of the one or more processors may include one or more processor cores. The communication interface 114 may communicatively couple the central server 110 to the network 170, and may be configured to operate in accordance with one or more communication protocols (e.g., an institute of electrical and electronics engineers (IEEE) 802.11, 802.15, 802.16 communication standard, a cellular communication standard, or other wired and/or wireless communication standards and protocols).

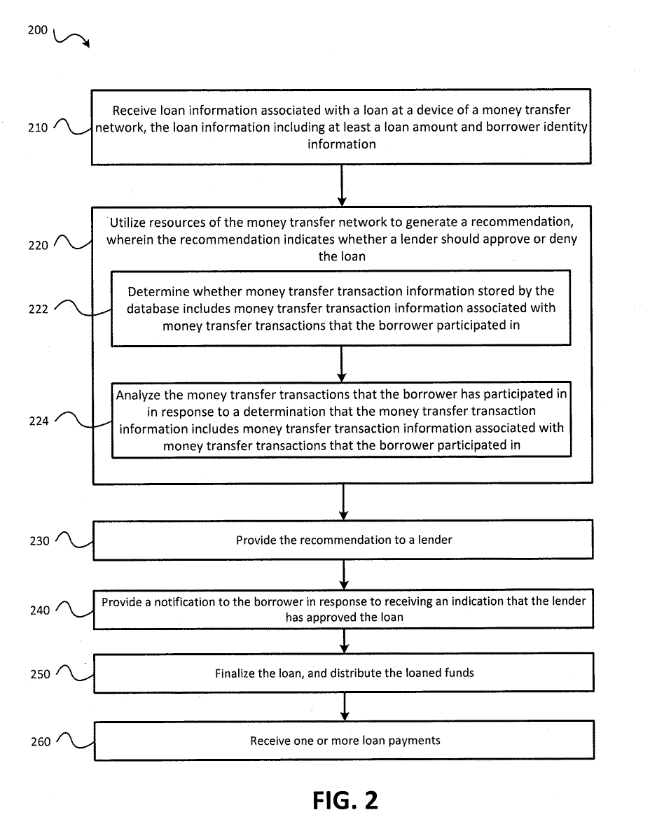

The memory 120 may store instructions 122 and a database 124. The instructions 122 may include instructions that, when executed by the processor 112, cause the processor 112 to perform operations for processing loans via a money transfer network, as described in connection with the central server 110 with reference to FIGS. 1 and 2. The database 124 may store information associated with one or more money transfer transactions provided money transfer locations operated by the money transfer service provider. For example, the database 124 may store profile information associated with one or more persons that have sent and/or received funds in connection with money transfer transactions provided by a money transfer location operated by the money transfer server provider, and may store transaction information associated with one or more money transfer transactions provided by money transfer locations operated by the money transfer server provider. The transaction information may include, for each money transfer transaction, information indicating a sending party (e.g., a party sending funds in connection with a money transfer transaction), a receiving party (e.g., a party receiving funds in connection with a money transfer transaction), an amount of funds transferred, a date the money transfer transaction was initiated, destination information indicating a money transfer location where the receiving party received the funds in connection with the money transfer transaction, origination information indication a money transfer location where the sending party provided funds in connection with the money transfer transaction, other information, or a combination thereof. Additionally, the database 124 may store location risk information identifying locations known to be associated with fraudulent transactions, criminal activity, or other unscrupulous behaviors, which may be used to determine whether a loan transaction is associated with a location that is identified by the location risk information, as described in more detail below.

In an embodiment, the database 124 may store lender information that identifies one or more lenders that provide loans to borrowers via the resources of the money transfer network. The lender information may include information associated with lending criteria associated with a particular lender. The lending criteria may indicate a maximum loan amount that the particular lender will participate in, borrower criteria information associated with the attributes of borrowers that the lender would like to provide loans to, regions or geographic areas of the world where the lender is willing to engage in loans with borrowers meeting the borrower criteria information, and other criteria, such as repayment terms, etc.

In an embodiment, the database 124 may be located external to the central server 110. For example, the database 124 may be stored at a network attached storage device external to the central server 110, a remote server (not shown in FIG. 1), or another location that is accessible to the central server 110 via the network 170. It is noted that although a single central server 110 is shown in FIG. 1, the system 100 may include a plurality of central distributed across one or more regions where a money transfer service provider operates one or more money transfer locations.

As shown in FIG. 1, the agent device 130 includes a processor 132, a communication interface 134, and a memory 140. It is noted that the processor 132 may include more than one processor, and each of the one or more processors may include one or more processor cores. The communication interface 134 may communicatively couple the agent device 130 to the network 170, and may be configured to operate in accordance with one or more communication protocols (e.g., an institute of electrical and electronics engineers (IEEE) 802.11, 802.15, 802.16 communication standard, a cellular communication standard, or other wired and/or wireless communication standards and protocols). The peripheral devices 136 may include a money order printer, an identification capture device (e.g., a signature pad, a camera, a pin pad module, a financial card reader, a biometric scanner, etc.), a receipt printer, another printing device, a barcode scanner, a metering device, a weight sensor, a check reader, a biometric input device (e.g., a fingerprint scanner, a retinal scanner, a palm print scanner, etc.), a microphone for receiving speech input, a keyboard, a mouse, other input devices, or any combination thereof. It is noted that although a single agent device 130 is shown in FIG. 1, the system 100 may include a plurality of agent devices distributed across one or more money transfer locations operated by a money transfer service provider.

The memory 140 may store instructions 142 and a database 144. The instructions 142 may include instructions that, when executed by the processor 132, cause the processor 132 to perform operations for processing loans via a money transfer network, as described in connection with the agent device 130 with reference to FIGS. 1 and 2. The database 144 may store information associated with one or more money transfer transactions provided by a money transfer location (e.g., a money transfer location associated with the agent device 130) operated by the money transfer service provider. For example, the database 144 may store profile information associated with one or more persons that have sent and/or received funds in connection with money transfer transactions provided by a money transfer location where the agent device 130 is located, and may store transaction information associated with one or more money transfer transactions provided by the money transfer location where the agent device 130 is located. The transaction information may include, for each money transfer transaction, information indicating a sending party (e.g., a party sending funds in connection with a money transfer transaction), a receiving party (e.g., a party receiving funds in connection with a money transfer transaction), an amount of funds transferred, a date the money transfer transaction was initiated, destination information indicating a money transfer location where the receiving party received the funds in connection with the money transfer transaction, origination information indication a money transfer location where the sending party provided funds in connection with the money transfer transaction, other information, or a combination thereof. Additionally, the database 144 may store location risk information identifying locations known to be associated with fraudulent transactions, criminal activity, or other unscrupulous behaviors, which may be used to determine whether a loan transaction is associated with a location that is identified by the location risk information, as described in more detail below.

In an embodiment, the database 144 may store lender information that identifies one or more lenders that provide loans to borrowers via the resources of the money transfer network. The lender information may include information associated with lending criteria associated with a particular lender. The lending criteria may indicate a maximum loan amount that the particular lender will participate in, borrower criteria information associated with the attributes of borrowers that the lender would like to provide loans to, regions or geographic areas of the world where the lender is willing to engage in loans with borrowers meeting the borrower criteria information, and other criteria, such as repayment terms, etc.

In an embodiment, the database 144 may be located external to the agent device 130. For example, the database 144 may be stored at a network attached storage device external to the agent device 130, a server (not shown in FIG. 1) remote to, or local to a money transfer location where the agent device 130 is located, or another location that is accessible to the agent device 130 via the network 170.

As shown in FIG. 1, the kiosk 150 includes a processor 152, a communication interface 154, and a memory 160. It is noted that the processor 152 may include more than one processor, and each of the one or more processors may include one or more processor cores. The communication interface 154 may communicatively couple the kiosk 150 to the network 170, and may be configured to operate in accordance with one or more communication protocols (e.g., an IEEE 802.11, 802.15, 802.16 communication standard, a cellular communication standard, or other wired and/or wireless communication standards and protocols). The peripheral devices 156 may include a money order printer, an identification capture device (e.g., a signature pad, a camera, a pin pad module, a financial card reader, a biometric scanner, etc.), a receipt printer, another printing device, a barcode scanner, a metering device, a weight sensor, a check reader, a biometric input device (e.g., a fingerprint scanner, a retinal scanner, a palm print scanner, etc.), a microphone for receiving speech input, a keyboard, a mouse, other input devices, or any combination thereof. It is noted that although a single kiosk 150 is shown in FIG. 1, the system 100 may include a plurality of kiosk distributed across one or more locations, which may include money transfer locations operated by a money transfer service provider, and may include other locations operated by entities other than the money transfer service provider, such as at grocery stores, malls, or other locations.

The memory 160 may store instructions 162 and a database 164. The instructions 162 may include instructions that, when executed by the processor 152, cause the processor 152 to perform operations for processing loans via a money transfer network, as described in connection with the kiosk 150 with reference to FIGS. 1 and 2. The database 164 may store information associated with one or more money transfer transactions provided by a money transfer location (e.g., a money transfer location associated with the kiosk 150) operated by the money transfer service provider. For example, the database 164 may store profile information associated with one or more persons that have sent and/or received funds in connection with money transfer transactions provided by a money transfer location where the kiosk 150 is located, and may store transaction information associated with one or more money transfer transactions provided by the money transfer location where the kiosk 150 is located. The transaction information may include, for each money transfer transaction, information indicating a sending party (e.g., a party sending funds in connection with a money transfer transaction), a receiving party (e.g., a party receiving funds in connection with a money transfer transaction), an amount of funds transferred, a date the money transfer transaction was initiated, destination information indicating a money transfer location where the receiving party received the funds in connection with the money transfer transaction, origination information indication a money transfer location where the sending party provided funds in connection with the money transfer transaction, other information, or a combination thereof. Additionally, the database 164 may store location risk information identifying locations known to be associated with fraudulent transactions, criminal activity, or other unscrupulous behaviors, which may be used to determine whether a loan transaction is associated with a location that is identified by the location risk information, as described in more detail below.

In an embodiment, the database 164 may store lender information that identifies one or more lenders that provide loans to borrowers via the resources of the money transfer network. The lender information may include information associated with lending criteria associated with a particular lender. The lending criteria may indicate a maximum loan amount that the particular lender will participate in, borrower criteria information associated with the attributes of borrowers that the lender would like to provide loans to, regions or geographic areas of the world where the lender is willing to engage in loans with borrowers meeting the borrower criteria information, and other criteria, such as repayment terms, etc.

In an embodiment, the database 144 may be located external to the kiosk 150. For example, the database 164 may be stored at a network attached storage device external to the kiosk 150, a server (not shown in FIG. 1) remote to, or local to a money transfer location where the kiosk 150 is located, or another location that is accessible to the kiosk 150 via the network 170.

As shown in FIG. 1, the central server 110, the agent device 130, and the kiosk 150 may be communicatively coupled to the lender device 180 and the user device 190 via the network 170. In an embodiment, the network 170 may be a wired network, a wireless network, or may include a combination of wired and wireless networks. For example, the network 170 may be a local area network (LAN), a wide area network (WAN), a wireless WAN, a wireless LAN (WLAN), a metropolitan area network (MAN), a wireless MAN network, a cellular data network, a cellular voice network, a public network (e.g., the internet), a private network (e.g., a private money transfer network operated by a money transfer service provider), other types of networks, or a combination thereof. In an embodiment, the network 170 may include multiple networks operated by different entities. For example, the network 170 may include a first network (e.g., a private money transfer network) operated by the money transfer service provider to facilitate communication between the central server 110, the agent device facility, a second network (e.g., a public network) that facilitates communication between the lender device 180, the user device 190, and the money transfer service provider devices such as the central server 110, the agent device 130, and/or the kiosk 150.

In an embodiment, the lender device 180 may be a server, a personal computer device, a tablet computing device, a mobile communication device, a smartphone device, a laptop computing device, another computing device, or a combination thereof, and may be operated by a lender that provides loans to individuals (e.g., an operator of the user device 190) and/or businesses. In an embodiment, the user device 190 may be a personal computer device, a tablet computing device, a mobile communication device, a smartphone device, a laptop computing device, another computing device, or a combination thereof.

During operation, loan information associated with a loan may be received at a device (e.g., one of the central server 110, the agent device 130, or the kiosk 150) of a money transfer network. In an embodiment, the loan information may be generated by a lender (e.g., an operator of the lender device 180) in connection with a loan requested by a borrower, and may be received from the lender device 180. In an embodiment, a user of the user device 190 may generate the loan information by filling out a form on a web page (e.g., a web page associated with the lender), and may be received in response to the user submitting the form. In an additional or alternative embodiment, the loan information may be received at the device of the money transfer network via inputs provided to the device. For example, a borrower may visit a money transfer location and request a loan, and an agent operating the agent device 130 may provide inputs to the agent device 130, where the inputs correspond to the loan information. As another example, the borrower may visit a location where the kiosk 150 is located and may provide inputs to the kiosk 150, where the inputs correspond to the loan information. In an embodiment, the agent device 130 and/or the kiosk 150 may be configured to present one or more graphical user interfaces (GUIs) at a display device, where the one or more GUIs prompt the agent or borrower to provide inputs corresponding to the loan information.

In an embodiment, the loan information may include a loan amount, borrower identity information, a loan amount (e.g., an amount of funds to be borrowed by the borrower), loan destination location information, loan origination location information, other information that may be required by the lender, or a combination thereof. The loan amount may indicate an amount of funds to be borrowed by the borrower. The borrower identity information may include information that identifies the borrower, and may include the borrower's name, address, social security number, birth date, e-mail address, telephone number, cell phone number, place of employment, etc. The loan origination location may identify a location where the loan is to be finalized. In an embodiment, the loan origination location is a money transfer location operated by the money transfer service provider. The loan destination location may identify a destination for funds associated with the loan. In an embodiment, the loan origination location and the loan destination location are different. For example, in an embodiment, the loan destination location may be in a different country than the loan origination location. As another example, the loan destination location may be in a different city than the loan origination location. In an additional or alternative embodiment, the loan information may further include information identifying a party that is to receive the loaned funds. When the loaned funds are to be provided to a third party (e.g., a party other than the borrower), the loan information may include information identifying the third party. For example, the borrower may have a family member that lives in a different country, state, city, etc., who may be experiencing financial hardship, and the borrower may request a loan, and indicate that the funds of the loan are to be provided to the family member. If the loan is ultimately approved by the lender, the funds may be provided via the money transfer network to the third party by a money transfer agent located at the loan destination location. Thus, one benefit of the system 100 is that the money transfer network may provide a more robust way to distribute loaned funds (e.g., distributing loaned funds to third parties in remote locations), as described in more detail below.

In an embodiment, when the borrower completes the form, or otherwise provides the information associated with the requested loan to the device, the device may identify one or more lenders for which the borrower satisfies the borrower criteria specified by the one or more identified lenders (e.g., based on the lender information stored at one or more of the respective databases 124, 144, 164). In an embodiment, the borrower may select a particular lender for the requested loan from among the one or more identified lenders, and the device may communicate information to the lender to indicate that the lender has a pending loan request. In an additional or alternative embodiment, the device may communicate the borrower information to each of the one or more identified lenders, and the lenders may then accept or reject the loan request. If multiple lenders accept the loan request, rules may be used to determine which of the multiple lenders is to fund the loan. In an embodiment, the rules may indicate that the loan is to be executed between the borrower and the first lender to accept the loan. In an additional or alternative embodiment, the lenders may be selected using a round robin scheme. In yet another additional or alternative embodiment, the loan is to be executed by multiple lenders as part of a lending group. For example, if two lenders indicate interest in the loan, the lenders may be virtually combined into a lending group (e.g., a virtual entity comprising the two lenders), where each lender shares in a proportional percentage of the loan transaction (e.g., for two lenders, each lender funds fifty percent (50%) of the loan). Other techniques may also be used to determine the lender or lenders that are to be associated with the loan transaction, and the exemplary techniques provided herein are for purposes of illustration, rather than by way of limitation. Once lenders have indicated an interest in accepting the loan, processing of the loan to determine whether the execute the loan transaction may occur, as described in more detail below.

Resources of the money transfer network may be utilized to generate a recommendation regarding the loan. In an embodiment, the recommendation may indicate whether the lender should approve the loan. In an embodiment, utilizing the resources of the money transfer network to provide an initial recommendation to the lender regarding whether the loan should be approved may assist individuals with little or no credit history in obtaining a loan, and consequently, establishing credit history.

The resources of the money transfer network that may be utilized to generate the recommendation may include a database (e.g., the database 124, 144, and/or 164) of the money transfer network. As explained above, the database may store money transfer transaction information associated with money transfer transactions that were provided via the money transfer network, and that the borrower has participated in, and this information may be used, at least in part, to generate the recommendation. For example, in response to receiving the loan information, the device (e.g., the central server 110, the agent device 130, or the kiosk 150) may determine whether money transfer transaction information stored by the database includes money transfer transaction information associated with money transfer transactions that the borrower participated in. In an embodiment, the device may query the database using the borrower identity information to determine whether the money transfer transaction information stored by the database includes money transfer transaction information associated with money transfer transactions that the borrower participated in. In response to a determination that the money transfer transaction information includes money transfer transaction information associated with money transfer transactions that the borrower participated in, the device may analyze the money transfer transactions that the borrower has participated, and may generate the recommendation generated based at least in part on the analysis.

In an embodiment, analyzing the money transfer transactions that the borrower has participated in to determine whether to approve may include determining a frequency of the money transfer transactions. For example, the money transfer transactions may be analyzed to determine how often the borrower participates in money transfer transactions. In an embodiment, the frequency may further be analyzed to determine a send frequency and a receive frequency (e.g., how often the borrower is a sender or receiver in connection with the money transfer transactions). The frequency information may be used, at least in part, to generate the recommendation by determining whether a timing of the loan satisfies the frequency characteristics of the money transfer transactions. For example, the frequency information may indicate that the borrower frequently receives funds in connection with the money transfer transactions, and rarely or never sends funds. This may result in a recommendation indicating that the loan should not be approved because the frequency information may indicate that the loan is an attempt to launder funds, whereby the borrower takes out a loan and then pays the loan back using funds received in money transfers. Such actions may not be readily detectable using traditional lending practices whereby only the lender is involved. For example, the lender may be able to obtain information from the borrower's bank, however, that information may not reflect the money transfer transactions whereby the borrower is frequently receiving funds. Thus, utilizing resources of the money transfer network to generate an initial recommendation for approving or denying the loan may reduce money laundering.

In an additional or alternative embodiment, analyzing the money transfer transactions that the borrower has participated in to determine whether to approve the loan may include determining an average amount of funds associated with the money transfer transactions. In an embodiment, the average amount of funds may compared to the loan amount to determine a difference between the average amount of funds and the loan amount, and the recommendation may be generated based at least in part on whether the difference exceeds a threshold. For example, when the borrower is frequently involved in money transfer transactions for a small amount, and the loan amount is substantially larger, this may indicate that the loan may be more risky to the lender (e.g., because the borrower is on average receiving or sending funds in an amount that is substantially smaller than the loan amount), and may result in a recommendation that the loan not be approved. Conversely, when the average money transfer transaction amount is substantially the same as or larger than the loan amount, this may indicate that the loan is less risky to the lender (e.g., because the borrower is on average receiving or sending funds in an amount that is greater than or equal to the loan amount), and may result in a recommendation that the loan be approved.

In an embodiment, the frequency information may be used in conjunction with the average loan amount information to generate the recommendation. For example, if the borrower is frequently sending funds, and rarely receives funds, the recommendation may indicate that the loan should be approved, even when the average send amount is substantially smaller than the loan amount. For example, assume that a borrower's average money transfer transaction is $200, and that the borrower is seeking approval of a loan for $1,000. Using average transaction amount alone may result in a recommendation to deny the loan because the average transaction amount is much smaller than the loan amount. However, the frequency information may indicate that the borrower is sending $200 every week to one or more destinations, which, in the aggregate would be $800/month. With this frequency information factored in, the recommendation may indicate that the loan should be approved, because the aggregate amount of funds being sent is closer to the loan amount.

In an additional or alternative embodiment, analyzing the money transfer transactions that the borrower has participated in to determine whether to approve the loan may include determining a receiver/sender ratio indicative of a ratio between a number of money transfer transactions in which the borrower received funds in a money transfer transaction, and a number of money transfer transactions in which the borrower sent funds in a money transfer transaction. The recommendation may be generated based at least in part on whether the receiver/sender ratio indicates that the borrower is a more frequent receiver of funds in money transfer transactions or a more frequent sender of funds in money transfer transactions. For example, if the receiver/sender ratio indicates that the borrower receives funds significantly more often than the borrower sends funds, the recommendation may indicate that the loan should not be approved by the lender (e.g., because the borrower appears to be constantly needing funds and may unlikely to be capable of repaying the loan). Utilizing resources of the money transfer network to determine the receiver/sender ratio his may reduce a number of loans that the lender approves to borrowers that are likely to be unable to pay. For example, if the borrower deposits the received funds at a bank, the received funds may appear as income, allowing the borrower to dupe the lender into thinking that the borrower makes more money than the borrower really does, which may cause the lender to approve the loan.

In an additional or alternative embodiment, analyzing the money transfer transactions that the borrower has participated in to determine whether to approve the loan may include identifying origination locations and destination locations associated with the money transfer transactions. The origination locations may correspond to (or identify) locations where each of the money transfer transactions originated (i.e., locations where funds for the money transfer transactions were provided to the money transfer service provider's agents), and the destination locations may correspond to (or identify) locations where each of the money transfer transactions terminated (i.e., locations where funds for the money transfer transactions were distributed to a receiving party by the money transfer service provider's agents). This information may be used to determine whether the loan origination location corresponds to at least one of the identified origination locations (e.g., whether locations where funds for a money transfer transaction that the borrower participated in correspond to the loan origination location). This information may additionally or alternatively be used to determine whether the loan destination location corresponds to at least one of the identified destination locations (e.g., whether locations where funds were distributed in connection with a money transfer transaction that the borrower participated in correspond to the loan destination location).

This information may be used to generate the recommendation to the lender. For example, if the loan destination location does not correspond to an origination or destination location associated with a previous money transfer transaction that the borrower has participated in, the destination may be deemed suspicious, and the recommendation may indicate that the loan should not be approved. Alternatively, when the loan destination location correspond to an origination or destination location associated with a previous money transfer transaction that the borrower has participated in, the destination may be deemed valid, and the recommendation may indicate that the loan should be approved. Additionally, the loan destination location may be analyze in conjunction with the origination and destination locations associated with the money transfer transactions that the borrower has participated in to determine whether the loan destination location is associated with a country known for being used to further criminal enterprise, such as through money laundering. Because the money transfer service provider may have locations in many such destinations, and be more familiar with entities receiving funds at such destinations, the money transfer service provider may be more qualified to evaluate whether providing the loaned funds to the loan destination location would further a criminal enterprise or not, and provide a recommendation to the lender that would prevent the loaned funds from being provided in furtherance of a criminal enterprise.

In addition to physical locations such as cities, money transfer agent locations, etc., the origination and destination locations may identity third parties (e.g., individuals) that were either sending or receiving parties in connection with money transfer transactions that the borrower participated in. When the loan destination location is not the borrower or a business, this information may be used to determine whether the borrower has previously participated in a money transfer transaction with the third party that is to receive the loaned funds. When the borrower has previously participated in a money transfer transaction with the third party, the recommendation may indicate that the loan should be approved, and when the borrower has not previously participated in a money transfer transaction with the third party, the recommendation may indicate that the loan should not be approved.

In an embodiment, the recommendation of whether to approve or deny the loan may be generated based on any combination of results of the various forms of analysis described above. For example, the analysis may include determining whether the recommendation should indicate that the loan should be approved or denied based on whether a majority of the above-described factors indicate that the loan should be approved or denied. In an embodiment, the factors may be weighted, such that some factors are relied upon more heavily than other factors. Further, it is noted that factors other than those described above may be used to determine whether the recommendation should indicate that the loan should be approved or denied, and the exemplary factors described above are provided for purposes of illustration, rather than by way of limitation. In response to completing the analysis, the device (e.g., the central server 110, the agent device 130, or the kiosk 150) may generate the recommendation, and may provide (e.g., using the communication interface 114, 134, 154, respectively) the recommendation to the lender via the network 170.

Subsequent to providing the recommendation to the lender (e.g., the lender device 180), the device may receive an indication that the loan has been approved or denied by the lender. In an embodiment, the indication that the loan has been approved or denied by the lender may be transmitted to the device by the lender device 180 in response to the lender evaluating information included in the recommendation. For example, the lender may receive the recommendation, and may further evaluate the loan information using the lender's own internal underwriting and risk assessment processes. The recommendation provided by the device may allow the lender to make a more informed decision with respect to approving or denying the loan. For example, as explained above, by initially evaluating or processing the loan information at the device using resources of the money transfer network, information that may otherwise be unavailable to the lender during the lender's internal underwriting and risk assessment evaluation may be accounted for. Thus, loans processed according to embodiments of the present disclosure, while unconventional in the field of loan processing, provide several advantages (e.g., having knowledge of non-credit transactions, such as money transfer transactions, that may provide an indication of the credit worthiness of an individual with no credit, fraud and money laundering prevention analysis and detection, etc.) for lenders that would otherwise be unavailable to the lender if a traditional loan underwriting process was used.

In response to receiving the indication that the loan has been approved or denied, the device may provide a notification to the borrower (e.g., to the user device 190). In an embodiment, the notification may be provided to the borrower via an e-mail message, a text message, an automated voice response message, a voice call, or a combination thereof. In an embodiment, the notification may indicate that the loan has been approved, and may include instructions for finalizing the loan at a money transfer location operating in the money transfer network. For example, the instructions may identify a money transfer location that the borrower is to visit to finalize the loan, where finalizing the loan may include completing paperwork, authenticating the borrower, and other actions, as may be specified by the lender and/or the money transfer service provider. In an embodiment, the indication may also include information that indicates when the lender is to provide funds in an amount corresponding to the loan amount to the money transfer agent. In an embodiment, the notification may indicate an earliest date that the loan may be finalized, where the earliest date is on or after a date upon which the lender is to provide the funds to the money transfer agent.

Subsequent to providing the notification, information for finalizing the money transfer transaction may be received from borrower at the device (e.g., the central server 110, the agent device 130, or the kiosk 150). The information may include identity information, and the identity information may be analyzed by the device (or an operator of the device) to authenticate an identity of the borrower. In an embodiment, the identity information may be authenticated to verify that the borrower has provided identification information that matches the identity information included in the loan information.

In an embodiment, the identity of the borrower may be authenticated using the resources of the money transfer network. For example, the resources of the money transfer network used to authenticate the identity of the borrower may include at least one of a biometric authentication technique, a photo identification authentication technique, a survey authentication technique, a voice recognition authentication technique, or a combination thereof. In an embodiment, authenticating the borrower's identify information using the biometric authentication technique may include receiving a biometric input from the borrower using a biometric input device (e.g., one of the biometric input devices included in the peripheral devices 136, 156) of the money transfer network, comparing the biometric input to an exemplary biometric input previously provided by the borrower in connection with a previously executed money transfer transaction provided via the money transfer network, and authenticating the identity of the borrower based on whether the biometric input matches the exemplary biometric input to within a threshold tolerance. In an embodiment, the biometric input received from the borrower may be provided to the central server 110, and the central server 110 may then determine whether the biometric input matches the exemplary biometric input to within the threshold tolerance. In an embodiment, authenticating the borrower's identify information using the photo identification authentication technique may include reading information from an identification card of the borrower using a card reader and authenticating that the information read from the identification card indicates that the card is valid; receiving an input indicating that an image present on the identification card matches the borrower; or a combination thereof. Further, some embodiments may further determine whether an image of the borrower, as found on the identification card, matches an image of the borrower captured from a third party, such as an image from a social media profile of the borrower, or an image captured of the borrower during a previously executed money transfer transaction. In an embodiment, authenticating the borrower's identify information using the survey authentication technique may include generating one or more questions associated with the borrower, prompting the borrower to answer the one or more questions, and determining whether answers provided by the borrower are correct. The questions may be derived from the money transfer transactions that the borrower has previously participated in, or may be derived from information obtained from a third party, such as information from a social media profile of the borrower, public records associated with the borrower, or another source. In an embodiment, authenticating the borrower's identify information using the voice recognition technique may include receiving a voice input from the borrower, comparing the voice input to an exemplary voice input previously provided by the borrower in connection with a previously executed money transfer transaction provided via the money transfer network, and authenticating the identity of the borrower when the voice input matches the exemplary voice input to within a threshold tolerance. In an embodiment, the voice input received from the borrower may be provided to the central server 110, and the central server 110 may then determine whether the voice input matches the exemplary voice input to within the threshold tolerance. Further, it is noted that the exemplary techniques for authenticating the identity of the borrower described above have been provided for purposes of illustration, rather than by way of limitation, and it is to be understood that the system 100 may alternatively or additionally use other techniques for authenticating the identity of the borrower.

In response to receiving the information and successfully authenticating the borrower's identity, the device may initiate distribution of funds associated with the loan via the money transfer network. In an embodiment, the funds may be distributed to the borrower directly. In an additional or alternative embodiment, the loan information may identify a third party that is to receive funds in connection with the loan, and the funds may be provided to the third party via the money transfer network (e.g., by a money transfer agent located at the loan destination location). In an embodiment, a notification may be provided to the third party in response to finalizing the loan (e.g., authenticating the identity of the borrower, completing any necessary paper work, etc.), where the notification to the third party indicates that the loaned funds are available for pickup by the third party at a money transfer location that is located at the loan destination location. In an embodiment, similar authentication and loan finalization procedures may be undertaken in connection with the third party that is to receive the loaned funds to ensure that the funds are provided to the third party identified in the loan information.

Distributing funds in connection with loans via the money transfer network may provide several advantages over conventional loaned funds distribution techniques. For example, a traditional lender, when distributing funds to a third party located in another country, may simply wire the funds to an account of the third party at a foreign bank designated by the borrower. Utilizing this technique does not provide for in-person authentication of the identity of the third party, and thus, using the money transfer network and money transfer agent locations to distribute the funds may provide a greater likelihood that the funds are provided to the correct third party, and are not being used for illicit purposes. Further, the money transfer service provider may be better suited to ensure that loaned funds are distributed in foreign countries in accordance with the appropriate domestic and foreign laws and controls, as may be specified by the Office of Foreign Assets Control (OFAC) or other governmental regulatory agencies.

Once the loan has been approved, finalized, and the funds have been distributed, the loan may enter a repayment period, which may vary with respect to the terms and conditions, repayment period/frequency, etc. In an embodiment, the borrower may make loan payments to the money transfer service provider, who may in turn provide the payments to the lender. In an embodiment, the money transfer agent service provider may charge a fee for receiving loan payments and for processing and distributing the loaned funds. In an embodiment, the money transfer service provider may further provide customer support on behalf of the lender in connection with the loan transaction. For example, when loaned funds are distributed in a foreign country, the money transfer service provider may be better suited to provide customer support because the money transfer service provider may have customer support personnel located in the various countries where the loaned funds may be distributed, enabling the money transfer service provider to provide local support at a time that is convenient to the party needing assistance. A benefit of processing and providing loan transactions using the resources of the money transfer network is that the money transfer service provider may be able to receive funding of the loan from the lender in first currency, and distribute the loaned funds to the borrower in a second currency, such as to facilitate loan transactions between lenders and borrowers in different countries and currencies.

From the foregoing it is shown that utilizing resources of a money transfer network to process loans may provide several advantages and improvements to the technical field of loan processing and funding. Further, the techniques for processing loans using money transfer network resources provides a mechanism for individuals with no credit history to begin establishing credit without resorting to credit cards or other forms of credit that may not provide a suitable means for using any funds that may be obtained from such sources. Thus, persons with no credit may be empowered to obtain loans to establish a small business, pay for emergency expenses, or other purposes where a traditional loan processing technique may otherwise deny such an opportunity.

Referring to FIG. 2, a flow diagram illustrating an exemplary embodiment of a method for processing loans via a money transfer network is shown as a method 200. In an embodiment, the method 200 may be stored as instructions (e.g., one or more of the instructions 122, 142, 162 of FIG. 1) that, when executed by a processor (e.g., one or more of the processors 112, 132, 152), cause the processor to perform operations for utilizing resources of a money transfer network to process a loan transaction. In an embodiment, the method 200 may be performed by the central server 110 of FIG. 1, the agent device 130 of FIG. 1, the kiosk 150 of FIG. 1, or any combination thereof.

At 210, the method 200 includes receiving loan information associated with a loan at a device of a money transfer network. In an embodiment, the loan information may include at least a loan amount and borrower identity information, where the loan amount indicates an amount of funds to be borrowed by a borrower, and the borrower identity information identifies the borrower. Further, it is noted that the loan information may include additional information, as described above with respect to FIG. 1. At 220, the method 200 includes utilizing resources of the money transfer network to generate a recommendation indicating whether a lender should approve or deny the loan. In an embodiment, the resources of the money transfer network may include a database (e.g., one or more of the databases 124, 144, 164 of FIG. 1) of the money transfer network. The database(s) may store money transfer transaction information associated with money transfer transactions provided via the money transfer network. In an embodiment, generating the recommendation to approve or deny the loan may include, at 222, determining whether money transfer transaction information stored by the database includes money transfer transaction information associated with money transfer transactions that the borrower participated in. Additionally, generating the recommendation may include, at 224, analyzing the money transfer transactions that the borrower has participated in response to a determination that the money transfer transaction information includes money transfer transaction information associated with money transfer transactions that the borrower participated in, where the recommendation is generated based at least in part on the information and the analysis. Such information and analysis may be used to identify potential risks (e.g., money laundering, inability to repay the loan, etc.) associated with the borrower and the loan that may otherwise be undiscoverable by the lender, and which may provide some indication of the borrower's credit worthiness when the borrower has little or no credit history.

At 230, the method 200 includes providing the recommendation to the lender, and, at 240, providing a notification to the borrower in response to receiving an indication that the lender has approved the loan. In an embodiment, the lender may factor the recommendation into its own internal due diligence processes to determine whether to approve or deny the loan. In an embodiment, the indication may indicate when the lender will provide funds to the money transfer service provider, who is then to distribute the loaned funds via the money transfer network. At 250, the method 200 includes finalizing the loan, which may include authenticating an identity of the borrower, and/or completing an necessary paperwork as may be required by the lender and/or the money transfer service provider. At 260, the method 200 includes receiving one or more loan payments from the borrower. Funds associated with the loan payments may be provided from the money transfer service provider to the lender.

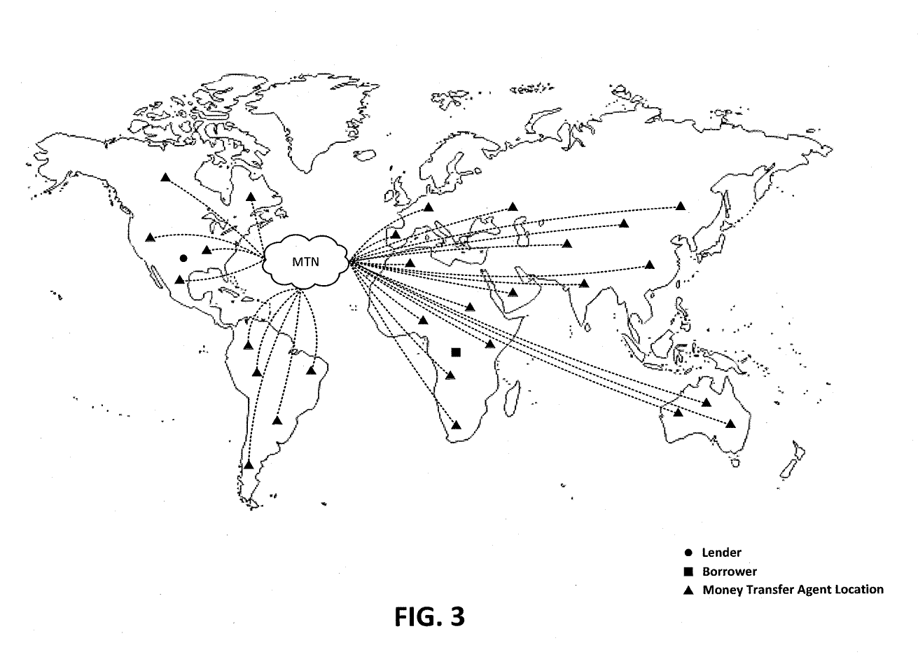

Microlending is a special type of loan transaction (e.g., a microloan) that is typically associated with a small loan amount (e.g., less than $1,000), and designed to promote entrepreneurship, alleviate poverty, empower women, and/or fulfill another beneficial need to members of society. Aspects of the present disclosure may be particularly suited for processing of microlending transactions. For example, referring to FIG. 3, a diagram illustrating exemplary aspects processing a microlending loan transaction according to embodiments is shown. As shown in FIG. 3, a money transfer service provider may provide a money transfer network (labeled MTN in FIG. 3) that interconnects a plurality of money transfer agent locations (shown as triangles in FIG. 3), and the plurality of money transfer agent locations may be distributed across various countries. The money transfer network may include a central server (e.g., the central server 110 of FIG. 1). Additionally, each money transfer agent location operating in the money transfer may include one or more agent devices (e.g., the agent device 130 of FIG. 1). Further, the money transfer network may include kiosks (e.g., the kiosk 150 of FIG. 1). The money transfer network devices (e.g., the central server, the agent devices, and the kiosks) may be configured to facilitate processing of loan transactions, and to facilitate distribution and repayment of loaned funds, as described above with respect to FIGS. 1 and 2.

During operation according to the embodiments illustrated in FIG. 3, a borrower (shown as a square in FIG. 3) in Sub Saharan Africa may not be able to obtain a loan from a local lender (e.g., because the lender does not have physical presence where the borrower is located, because the lender does not provide loans in the amount requested by the borrower, because the borrower does not have any credit history, or other reasons). According to embodiments, a woman (e.g., a borrower) may initiate a loan transaction that may be processed and/or provided using resources of the money transfer network. For example, the woman may visit a kiosk and use one or more graphical user interfaces (GUIs) presented by the kiosk to provide loan information (e.g., the loan information described with reference to FIG. 1) in connection with a request for a microloan transaction. As another example, the woman may visit a money transfer agent location, and a money transfer agent may provide inputs associated with loan information to an agent device in connection with a request for a microloan transaction. As yet a further example, the woman may visit a web page associated with the money transfer service provider, and may provide the loan information to a central server via a GUI of the web page. In embodiment, the GUI may enable the woman to search a list of lenders that provide microlending transactions, and may designate one or more of the lenders as a candidate lender (e.g., a lender that the borrower desires to enter into a lending transaction with) for the requested loan transaction.

The money transfer network may receive the loan information and the designation of the one or more candidate lenders, and may analyze the loan information, as described above with reference to FIGS. 1 and 2, to generate a recommendation to the candidate lender(s), where the recommendation may indicate whether the money transfer service provider recommends that the candidate lender approve or deny the requested microlending transaction. The candidate lender(s) may provide a notification to the money transfer network indicating that the requested microlending transaction has been approved or denied. As illustrated in FIG. 3, utilizing the money transfer network to process loan transactions may enable the woman in Sub Saharan Africa to request a loan from a lender (shown as a circle in FIG. 3) that is located in a different country (e.g., the United States of America). If the lender approves the loan, the money transfer network may be used to fund the loan (e.g., the lender may provide payment of funds in an amount corresponding to the loan amount, to the money transfer network), to notify the woman that the loan has been approved (or denied), and to distribute the loaned funds to the woman. After the loaned funds have been distributed to the woman, the loan may enter a repayment period. The woman may make loan payments at her local money transfer agent location, and the local money transfer agent may then route payment of the loaned funds to the lender via the money transfer network. Thus, utilizing the money transfer network enables loans to be transacted across geographical disparate locations (e.g., loan transactions between the United States of America and Sub Saharan Africa), enabling loan transactions to be provided to regions where traditional lenders do not have a presence, or where lenders are present but do not provide loans suitable for some borrowers (e.g., women and other borrowers requiring microlending transactions).

Although the embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for utilizing a money transfer network to process a loan transaction, the method comprising:
receiving loan information associated with a microloan, wherein the loan information is provided to a device at a money transfer network agent location, the loan information including at least a loan amount for the microloan and borrower identity information, wherein the loan amount indicates an amount of funds to be borrowed by a borrower in connection with the microloan, and wherein the borrower identity information identifies the borrower;
sending the loan information to a lender, wherein the lender is geographically remote from the borrower and the device of the money transfer network;
receiving approval of the microloan from the lender; and
establishing a money transfer transaction to fund the microloan via the money transfer network, wherein funding the microloan includes providing the amount of funds indicated by the loan amount to the borrower.

2. The method of claim 1, wherein the method includes:
utilizing resources of the money transfer network to generate a recommendation, wherein the recommendation indicates whether a lender should approve the microloan, wherein the resources include a database of the money transfer network, wherein the database stores money transfer transaction information associated with money transfer transactions provided via the money transfer network, and wherein approval of the loan is determined by:
querying the database using the borrower identity information to determine whether the money transfer transaction information stored by the database includes money transfer transaction information associated with money transfer transactions that the borrower participated in; and
in response to a determination that the money transfer transaction information includes money transfer transaction information associated with money transfer transactions that the borrower participated in, analyzing the money transfer transactions that the borrower has participated, wherein the recommendation is generated based at least in part on the analysis; and
providing the recommendation, wherein the approval of the microloan is received from the lender subsequent to providing the recommendation.

3. The method of claim 2, wherein analyzing the money transfer transactions that the borrower has participated in to determine whether to approve the loan includes at least one of:
determining a frequency of the money transfer transactions;
determining an average amount of funds associated with the money transfer transactions;
determining a receiver/sender ratio indicative of a ratio between a number of money transfer transactions in which the borrower received funds and a number of money transfer transactions in which the borrower sent funds; and
identifying origination locations and destination locations associated with the money transfer transactions, the origination locations corresponding to locations where each of the money transfer transactions originated, and the destination locations corresponding to locations where each of the money transfer transactions terminated.

4. The method of claim 3, wherein the analyzing includes:
determining a difference between the average amount of funds and the loan amount;
determining whether the difference exceeds a threshold; and
generating a recommendation indicating that the loan should be approved when the difference does not exceed the threshold.

5. The method of claim 3, wherein the loan information indicates a loan origination location and a loan destination location, wherein the loan origination location identifies a location where the loan is to be finalized, and the loan destination location identifies a destination for funds associated with the loan.

6. The method of claim 5, wherein the loan origination location and the loan destination location are different.

7. The method of claim 6, wherein the loan destination location is in a different country than the loan origination location.

8. The method of claim 5, wherein the loan information identifies a third party that is to receive the funds in connection with the loan, and wherein the funds are provided via the money transfer network to the third party by a money transfer agent located at the loan destination location.

9. The method of claim 2, wherein the method includes:
receiving an indication that the loan has been approved by the lender, wherein the indication that the microloan has been approved by the lender is transmitted in response to the lender evaluating information included in the recommendation;
in response to receiving the indication that the microloan has been approved, providing a notification to the borrower, wherein the notification indicates that the microloan has been approved and includes instructions for finalizing the microloan at a money transfer location operating in the money transfer network;
subsequent to providing the notification, receiving information from the borrower for finalizing the money transfer transaction at an agent device operating in the money transfer network; and
in response to receiving the information, initiating distribution of funds associated with the microloan via the money transfer network.

10. The method of claim 9, wherein the indication includes information that indicates when the lender is to provide funds in an amount corresponding to the loan amount to a money transfer agent, wherein the notification indicates an earliest date that the loan may be finalized, and wherein the earliest date is on or after a date upon which the lender is to provide the funds to the money transfer agent.

11. The method of claim 9, wherein the method includes authenticating an identity of the borrower to finalize the loan using the resources of the money transfer network, wherein the resources of the money transfer network used to authenticate the identity of the borrower include at least one of a biometric authentication technique, a photo identification authentication technique, a survey authentication technique, a voice recognition authentication technique, or a combination thereof.

12. The method of claim 11, wherein the biometric authentication technique includes: receiving a biometric input from the borrower using a biometric input device of the money transfer network, comparing the biometric input to an exemplary biometric input previously provided by the borrower in connection with a previously executed money transfer transaction provided via the money transfer network, and authenticating the identity of the borrower when the biometric input matches the exemplary biometric input to within a threshold tolerance; wherein the photo identification authentication technique includes at least one of: reading information from an identification card of the borrower using a card reader and authenticating that the information read from the identification card indicates that the card is valid, receiving an input indicating that an image present on the identification card matches the borrower, or a combination thereof; wherein the survey authentication technique includes: generating one or more questions associated with the borrower, prompting the borrower to answer the one or more questions, and determining whether answers provided by the borrower are correct; and wherein the voice recognition technique includes: receiving a voice input from the borrower; comparing the voice input to an exemplary voice input previously provided by the borrower in connection with a previously executed money transfer transaction provided via the money transfer network, and authenticating the identity of the borrower when the voice input matches the exemplary voice input to within a threshold tolerance.

13. A money transfer network device configured to process a loan transaction, the money transfer device comprising:
at least one processor configured to:
receive loan information associated with a loan via a money transfer network, the loan information including at least a loan amount and borrower identity information, wherein the loan amount indicates an amount of funds to be borrowed by a borrower, and wherein the borrower identity information identifies the borrower;
utilize resources of the money transfer network to generate a recommendation, wherein the recommendation indicates whether a lender should approve the loan, wherein the resources include a database of the money transfer network, wherein the database stores money transfer transaction information associated with money transfer transactions provided via the money transfer network, and wherein approval of the loan is determined by:
determining whether money transfer transaction information stored by the database includes money transfer transaction information associated with money transfer transactions that the borrower participated in; and
in response to a determination that the money transfer transaction information includes money transfer transaction information associated with money transfer transactions that the borrower participated in, analyzing the money transfer transactions that the borrower has participated, wherein the recommendation is generated based at least in part on the analysis; and
providing the recommendation to a lender; and
a memory coupled to the at least one processor.

14. The money transfer network device of claim 13, wherein the at least one processor is configured to query the database using the borrower identity information to determine whether the money transfer transaction information stored by the database includes money transfer transaction information associated with money transfer transactions that the borrower participated in.

15. The money transfer network device of claim 13, wherein analyzing the money transfer transactions that the borrower has participated in to determine whether to approve the loan includes at least one of:
determining a frequency of the money transfer transactions, wherein the recommendation is generated based at least in part on whether a timing of the loan satisfies the frequency of the money transfer transactions;
determining an average amount of funds associated with the money transfer transactions, wherein the average amount of funds is compared to the loan amount to determine a difference between the average amount of funds and the loan amount, and wherein the recommendation is generated based at least in part on whether the difference exceeds a threshold;
determining a receiver/sender ratio indicative of a ratio between a number of money transfer transactions in which the borrower received funds and a number of money transfer transactions in which the borrower sent funds, wherein the recommendation is generated based at least in part on whether the ratio indicates the borrower is a more frequent receiver of funds in money transfer transaction or a more frequent sender of funds in money transfer transactions; and
identifying origination locations and destination locations associated with the money transfer transactions, the origination locations corresponding to locations where each of the money transfer transactions originated, and the destination locations corresponding to locations where each of the money transfer transactions terminated, wherein the recommendation is generated based at least in part on whether a loan origination location corresponds to at least one of the original locations, whether a loan destination location corresponds to at least one of the destination locations, or a combination thereof, wherein the loan origination location and the loan destination location are included in the loan information indicates an origination location and a destination location, wherein the loan origination location identifies a location where the loan is to be finalized, and the loan destination location identifies a destination for funds associated with the loan.

16. The money transfer network device of claim 15, wherein the loan information identifies a third party that is to receive funds in connection with the loan, and wherein the funds are provided to the third party via the money transfer network by a money transfer agent located at the loan destination location.

17. The money transfer network device of claim 13, wherein the at least one processor is configured to:
receive an indication that the loan has been approved by the lender, wherein the indication that the loan has been approved by the lender is transmitted in response to the lender evaluating information included in the recommendation, wherein the indication includes information that indicates when the lender is to provide funds in an amount corresponding to the loan amount to a money transfer agent;
in response to receiving the indication that the loan has been approved, provide a notification to the borrower, wherein the notification indicates that the loan has been approved and includes instructions for finalizing the loan at a money transfer location operating in the money transfer network, and wherein the notification is provided to the borrower via an e-mail message, a text message, an automated voice response message, a voice call, or a combination thereof, wherein the notification indicates an earliest date that the loan may be finalized, and wherein the earliest date is on or after a date upon which the lender is to provide the funds to the money transfer agent;
subsequent to providing the notification, receive information from the borrower for finalizing the money transfer transaction; and
in response to receiving the information, initiating distribution of funds in connection with the loan via the money transfer network.

18. The money transfer network device of claim 13, wherein the at least one processor is configured to authenticating an identity of the borrower to finalize the loan using the resources of the money transfer network, wherein the resources of the money transfer network used to authenticate the identity of the borrower include at least one of a biometric authentication technique, a photo identification authentication technique, a survey authentication technique, a voice recognition authentication technique, or a combination thereof.

19. A non-transitory computer-readable storage medium storing instruction that, when executed by a processor, cause the processor to perform operations for utilizing a money transfer network to process a loan transaction, the operations comprising:
receiving loan information associated with a loan at a device of a money transfer network, the loan information including at least a loan amount and borrower identity information, wherein the loan amount indicates an amount of funds to be borrowed by a borrower, and wherein the borrower identity information identifies the borrower;
utilizing resources of the money transfer network to generate a recommendation, wherein the recommendation indicates whether a lender should approve the loan, wherein the resources include a database of the money transfer network, wherein the database stores money transfer transaction information associated with money transfer transactions provided via the money transfer network, and wherein approval of the loan is determined by:
determining whether money transfer transaction information stored by the database includes money transfer transaction information associated with money transfer transactions that the borrower participated in; and
in response to a determination that the money transfer transaction information includes money transfer transaction information associated with money transfer transactions that the borrower participated in, analyzing the money transfer transactions that the borrower has participated, wherein the recommendation is generated based at least in part on the analysis; and
providing the recommendation to a lender;
receiving an indication that the loan has been approved by the lender, wherein the indication that the loan has been approved by the lender is transmitted in response to the lender evaluating information included in the recommendation, and wherein the indication includes information that indicates when the lender is to provide funds in an amount corresponding to the loan amount to a money transfer agent;
in response to receiving the indication that the loan has been approved, providing a notification to the borrower, wherein the notification indicates that the loan has been approved and includes instructions for finalizing the loan at a money transfer location operating in the money transfer network;
subsequent to providing the notification, receiving information from the borrower for finalizing the money transfer transaction; and
in response to receiving the information, initiating distribution of funds in connection with the loan via the money transfer network.

20. The non-transitory computer-readable storage medium of claim 19, wherein the operations for analyzing the money transfer transactions that the borrower has participated in to determine whether to approve the include at least one of:
determining a frequency of the money transfer transactions, wherein the recommendation is generated based at least in part on whether a timing of the loan satisfies the frequency of the money transfer transactions;
determining an average amount of funds associated with the money transfer transactions, wherein the average amount of funds is compared to the loan amount to determine a difference between the average amount of funds and the loan amount, and wherein the recommendation is generated based at least in part on whether the difference exceeds a threshold;
determining a receiver/sender ratio indicative of a ratio between a number of money transfer transactions in which the borrower received funds and a number of money transfer transactions in which the borrower sent funds, wherein the recommendation is generated based at least in part on whether the ratio indicates the borrower is a more frequent receiver of funds in money transfer transaction or a more frequent sender of funds in money transfer transactions; and
identifying origination locations and destination locations associated with the money transfer transactions, the origination locations corresponding to locations where each of the money transfer transactions originated, and the destination locations corresponding to locations where each of the money transfer transactions terminated, wherein the recommendation is generated based at least in part on whether a loan origination location corresponds to at least one of the original locations, whether a loan destination location corresponds to at least one of the destination locations, or a combination thereof, wherein the loan origination location and the loan destination location are included in the loan information indicates an origination location and a destination location, wherein the loan origination location identifies a location where the loan is to be finalized, and the loan destination location identifies a destination for funds associated with the loan.
